(19) United States
(12) Patent Application Publication
(10) Pub. No.: US 2026/0051998 A1
(43) Pub. Date: Feb. 19, 2026

(54) METHODS AND APPARATUS FOR DYNAMIC UPLINK TX SWITCHING

(71) Applicant: Apple Inc., Cupertino, CA (US)

(72) Inventors: Ankit Bhamri, Bad Nauheim (DE); Chunhai Yao, Beijing (CN); Dawei Zhang, Saratoga, CA (US); Oghenekome Oteri, San Diego, CA (US); Sigen Ye, Whitehouse Station, NJ (US); Wei Zeng, Saratoga, CA (US); Yang Tang, San Jose, CA (US)

(21) Appl. No.: 19/101,735

(22) PCT Filed: Aug. 12, 2022
(86) PCT No.: PCT/CN2022/112156

§ 371 Date: Feb. 6, 2025

(51) Int. Cl. H04L 5/00

(52) U.S. Cl. CPC H04L 5/0096

(57) ABSTRACT

Methods, systems, devices, and computer programs for dynamic uplink (UL) transmission (Tx) switching by a UE. In one aspect, the method can include actions of transmitting, by the UE and to an access node, a UE capability report describing UL Tx switching capabilities of the UE, receiving, by the UE and from the access node, signaling that configures dynamic UL Tx switching criteria on the UE based on the UL Tx switching capabilities of the UE, wherein the dynamic UL Tx switching criteria specifies a minimum duration of time for a first switching instance, wherein the minimum duration of time specifies a duration of time the UE waits, after performance of the first switching instance, before performing another switching instance, and scheduling, by the UE, UL Tx switching based on the configured dynamic UL Tx switching criteria.

### BACKGROUND

User equipment (UE) can perform uplink transmissions using one or more bands (or carriers). Uplink transmission switching occurs when a UE switches uplink transmission from one or more first bands (or carriers) to one or more other bands (or carriers).

### SUMMARY

According to one innovative aspect of the present disclosure, a method for dynamic uplink (UL) transmission (Tx) switching by a UE is disclosed. In one aspect, the method can include actions of transmitting, by the UE and to an access node, a UE capability report describing UL Tx switching capabilities of the UE, receiving, by the UE and from the access node, signaling that configures dynamic UL Tx switching criteria on the UE based on the UL Tx switching capabilities of the UE, wherein the dynamic UL Tx switching criteria specifies a minimum duration of time for a first switching instance, wherein the minimum duration of time specifies a duration of time the UE waits, after performance of the first switching instance, before performing another switching instance, and scheduling, by the UE, UL Tx switching based on the configured dynamic UL Tx switching criteria.

Other aspects include apparatuses, systems, and computer programs for performing the actions of the aforementioned method.

The innovative method can include other optional features. For example, in some implementations, the first switching instance corresponds to an UL Tx switch from an initial state of a UL Tx chain to a subsequent state of the UL Tx chain, and the other switching instance corresponds to an UL Tx switch from the subsequent state of the UL Tx chain to any other state of the UL Tx chain.

In some implementations, the initial state of a UL Tx chain can include a single band and the subsequent state of the UL Tx chain includes a single band.

In some implementations, the initial state of a UL Tx chain can include multiple bands and the subsequent state of the UL Tx chain includes a single band.

In some implementations, the initial state of a UL Tx chain can include a single band and the subsequent state of the UL Tx chain includes multiple bands.

In some implementations, the minimum duration of time is specified in terms of a number of slots or symbols. In some implementations, the number of slots or symbols is based on the numerology associated with each band or carrier of the switching case.

In some implementations, the minimum duration of time is associated with the stage change of UL Tx chains.

In some implementations, the UE capability report describing UL Tx switching capabilities can include (i) a set of switching cases that the UE is capable of supporting for dynamic UL Tx switching, (ii) a minimum required switching gap for a given switching case, ort (iii) UE processing capability type, (iv) associated traffic priority, (v) associated priority with one or more switching cases, (vi) type of switching case, or (vii) frequency range.

In some implementations, the associated traffic priority can include ultra reliable low latency communications (URLLC) or enhanced mobile broadband (eMBB).

In some implementations, the associated priority with one or more switching cases can include an associated priority with one or more bands or one or more carriers.

In some implementations, the type of switching case includes a band type.

In some implementations, the band type is supplemental uplink (SUL) or normal uplink (NUL).

In some implementations, the dynamic UL Tx switching criteria can include a dynamic UL Tx switching mapping table.

In some implementations, the method can further include determining, by the UE, a particular switching instance, wherein a particular switching instance includes an UL Tx switch from an initial state of a UL Tx chain to a subsequent state of the UL Tx chain, and determining, by the UE, a duration of time that corresponds to the particular switching instance based from the dynamic uplink mapping table. In such implementations, scheduling, by the UE, UL Tx switching based on the configured UL Tx switching criteria can include scheduling, by the UE, UL Tx switching without an occurrence of an UL Tx switch from the subsequent state of the UL Tx chain to any other state of the UL Tx chain for at least the determined duration of time.

In some implementations, the dynamic UL Tx switching mapping table can include a plurality of entries, wherein each entry in the dynamic UL Tx switching mapping table corresponds to particular switching case.

In some implementations, the dynamic UL Tx switching mapping table can include a plurality of entries, wherein each entry in the dynamic UL Tx switching mapping table associates (i) a particular switching case with (ii) a minimum duration that must elapse after a switching instances occurs that corresponds to the particular switching case before the UE can perform another UL Tx switch.

In some implementations, the dynamic UL Tx switching criteria on the UE is determined based on the UL Tx switching capabilities of the UE.

In some implementations, each entry in the dynamic UL Tx switching mapping table can include an index.

In some implementations, the dynamic UL Tx switching criteria can include multiple different sets of dynamic UL Tx switching criteria, and each set of dynamic UL Tx switching criteria is associated with a UE capability type.

In some implementations, scheduling, by the UE, UL Tx switching based on the configured dynamic UL Tx switching criteria can include determining, by the UE, an actual UE capability type for the UE, and scheduling, by the UE, UL Tx switching based on the dynamic UL Tx switching criteria that is associated with the actual UE capability type determined by the UE.

In some implementations, the dynamic UL Tx switching criteria can include multiple different sets of dynamic UL Tx switching criteria, and each set of dynamic UL Tx switching criteria is associated with a UE switching mode. In such implementations, scheduling, by the UE, UL Tx switching based on the configured dynamic UL Tx switching criteria can include determining, by the UE, an actual UE switching mode for the UE, and scheduling, by the UE, UL Tx switching based on the dynamic UL Tx switching criteria that is associated with the actual UE switching mode determined by the UE.

In some implementations, the UE switching mode can include (i) a switched UL or (ii) a dual UL mode.

In some implementations, the UE transmits signaling describing UL Tx switching capabilities of the UE to the access node using radio resource control (RRC) signaling.

In some implementations, the UE receives signaling that configures dynamic UL Tx switching criteria on the UE based on the UL Tx switching capabilities of the UE from the access node using radio resource control (RRC) signaling. According to another innovative aspect of the present disclosure, another method for dynamic uplink (UL) transmission (Tx) switching by a UE is disclosed. In one aspect, the method can include actions of transmitting, by the UE and to an access node, a UE capability report describing UL Tx switching capabilities of the UE, receiving, by the UE and from the access node, signaling that configures dynamic UL Tx switching criteria on the UE based on the UL Tx switching capabilities of the UE, wherein the dynamic UL Tx switching criteria specifies a minimum duration of time for a first switching instance, wherein the minimum duration of time specifies a duration of time the UE waits, after performance of the first switching instance, before performing another switching instance, and performing, by the UE, UL Tx switching at the first switching instance based on the configured dynamic UL Tx switching criteria.

Other aspects include apparatuses, systems, and computer programs for performing the actions of the aforementioned method.

The innovative method can include other optional features. For example, in some implementations, the first switching instance corresponds to an UL Tx switch from an initial state of a UL Tx chain to a subsequent state of the UL Tx chain, and the other switching instance corresponds to an UL Tx switch from the subsequent state of the UL Tx chain to any other state of the UL Tx chain.

In some implementations, the initial state of a UL Tx chain can include a single band and the subsequent state of the UL Tx chain includes a single band.

In some implementations, the initial state of a UL Tx chain can include multiple bands and the subsequent state of the UL Tx chain includes a single band.

In some implementations, the initial state of a UL Tx chain can include a single band and the subsequent state of the UL Tx chain includes multiple bands.

In some implementations, the minimum duration of time is specified in terms of a number of slots or symbols. In some implementations, the number of slots or symbols is based on the numerology associated with each band or carrier of the switching case.

In some implementations, the minimum duration of time is associated with the stage change of UL Tx chains.

In some implementations, the UE capability report describing UL Tx switching capabilities can include (i) a set of switching cases that the UE is capable of supporting for dynamic UL Tx switching, (ii) a minimum required switching gap for a given switching case, ort (iii) UE processing capability type, (iv) associated traffic priority, (v) associated priority with one or more switching cases, (vi) type of switching case, or (vii) frequency range.

In some implementations, the associated traffic priority can include ultra reliable low latency communications (URLLC) or enhanced mobile broadband (eMBB).

In some implementations, the associated priority with one or more switching cases can include an associated priority with one or more bands or one or more carriers.

In some implementations, the type of switching case includes a band type.

In some implementations, the band type is supplemental uplink (SUL) or normal uplink (NUL).

In some implementations, the dynamic UL Tx switching criteria can include a dynamic UL Tx switching mapping table.

In some implementations, the method can further include determining, by the UE, a particular switching instance, wherein a particular switching instance includes an UL Tx switch from an initial state of a UL Tx chain to a subsequent state of the UL Tx chain, and determining, by the UE, a duration of time that corresponds to the particular switching instance based from the dynamic uplink mapping table. In such implementations, scheduling, by the UE, UL Tx switching based on the configured UL Tx switching criteria can include scheduling, by the UE, UL Tx switching without an occurrence of an UL Tx switch from the subsequent state of the UL Tx chain to any other state of the UL Tx chain for at least the determined duration of time.

In some implementations, the dynamic UL Tx switching mapping table can include a plurality of entries, wherein each entry in the dynamic UL Tx switching mapping table corresponds to particular switching case.

In some implementations, the dynamic UL Tx switching mapping table can include a plurality of entries, wherein each entry in the dynamic UL Tx switching mapping table associates (i) a particular switching case with (ii) a minimum duration that must elapse after a switching instances occurs that corresponds to the particular switching case before the UE can perform another UL Tx switch.

In some implementations, the dynamic UL Tx switching criteria on the UE is determined based on the UL Tx switching capabilities of the UE.

In some implementations, each entry in the dynamic UL Tx switching mapping table can include an index.

In some implementations, the dynamic UL Tx switching criteria can include multiple different sets of dynamic UL Tx switching criteria, and each set of dynamic UL Tx switching criteria is associated with a UE capability type.

In some implementations, scheduling, by the UE, UL Tx switching based on the configured dynamic UL Tx switching criteria can include determining, by the UE, an actual UE capability type for the UE, and scheduling, by the UE, UL Tx switching based on the dynamic UL Tx switching criteria that is associated with the actual UE capability type determined by the UE.

In some implementations, the dynamic UL Tx switching criteria can include multiple different sets of dynamic UL Tx switching criteria, and each set of dynamic UL Tx switching criteria is associated with a UE switching mode. In such implementations, scheduling, by the UE, UL Tx switching based on the configured dynamic UL Tx switching criteria can include determining, by the UE, an actual UE switching mode for the UE, and scheduling, by the UE, UL Tx switching based on the dynamic UL Tx switching criteria that is associated with the actual UE switching mode determined by the UE.

In some implementations, the UE switching mode can include (i) a switched UL or (ii) a dual UL mode.

In some implementations, the UE transmits signaling describing UL Tx switching capabilities of the UE to the access node using radio resource control (RRC) signaling.

In some implementations, the UE receives signaling that configures dynamic UL Tx switching criteria on the UE based on the UL Tx switching capabilities of the UE from the access node using radio resource control (RRC) signaling.

According to another innovative aspect of the present disclosure, another method for dynamic uplink (UL) transmission (Tx) switching by a UE is disclosed. In one aspect, the method can include actions of determining, by a UE, that the UE is to perform an UL Tx switch from an initial state of a UL Tx chain to a subsequent state of the UL Tx chain, determining, by the UE and based on dynamic UL Tx switching criteria stored by the UE, whether the UE is permitted to perform the UL Tx switch from the initial state of the UL Tx chain to the subsequent state of the UL Tx chain, and based on a determination, by the UE, that the performance of an UL Tx switch from the initial state of the UL Tx chain to the subsequent state of the UL Tx chain does not satisfy the dynamic UL Tx switching criteria stored by the UE, determining, by the UE, to not perform the UL Tx switch from the initial state of the UL Tx chain to the subsequent state of the UL Tx chain.

Other aspects include apparatuses, systems, and computer programs for performing the actions of the aforementioned method.

The innovative method can include other optional features. For example, in some implementations, based on a determination, by the UE, that the performance of an UL Tx switch from the initial state of the UL Tx chain to the subsequent state of the UL Tx chain satisfies the dynamic UL Tx switching criteria stored by the UE, performing, by the UE, the UL Tx switch from the initial state of the UL Tx chain to the subsequent state of the UL Tx chain.

In some implementations, the initial state of the UL Tx chain can include a single band or a single carrier and the subsequent state includes a single bad or a single carrier.

In some implementations, the initial state of the UL Tx chain can include multiple bands and the second set of one or more bands includes a single band.

In some implementations, the initial state of the UL Tx chain can include a single band and the second set of one or more bands includes multiple bands.

In some implementations, the initial state of the UL Tx chain can include multiple bands and the second set of one or more bands includes multiple bands.

In some implementations, the dynamic UL Tx switching criteria can include a predetermined minimum duration of time between the initial state of the UL Tx chain and the second set of one or more bands.

In some implementations, the dynamic UL Tx switching criteria can include a dynamic uplink UL Tx switching mapping table.

In some implementations, the dynamic UL Tx switching mapping table can include a plurality of entries, wherein each entry in the dynamic UL Tx switching mapping table corresponds to a particular switching case.

In some implementations, the dynamic UL Tx switching mapping table can include a plurality of entries, wherein each entry in the dynamic UL Tx switching mapping table associates (i) a particular switching case with (ii) a minimum duration that must elapse after a switching instances occurs that corresponds to the particular switching case before the UE can perform another UL Tx switch.

In some implementations, each entry in the dynamic UL Tx switching mapping table can include an index.

### BRIEF DESCRIPTION OF DRAWINGS

FIG. 1 is a conceptual diagram of a switching event that highlights concepts related to dynamic uplink TX switching.

FIG. 2 is a conceptual diagram of an example of a two switching instances that are the same.

FIG. 3 is a conceptual diagram of an example of two switching instances that are different.

FIG. 4. is a flowchart of an example of a process for dynamic uplink (UL) transmission (Tx) switching, in accordance with one aspect of the present disclosure.

FIG. 4A is a flowchart of an example of another process for dynamic UL Tx switching, in accordance with one aspect of the present disclosure.

FIG. 5 is an example of a wireless communication system.

FIG. 6 is a block diagram of an example of user equipment (UE).

FIG. 7 is a block diagram of an example of an access node.

Like reference symbols in the various drawings indicate like elements.

### DETAILED DESCRIPTION

Increasing the number of bands and/or carriers for uplink (UL) transmission (Tx) switching provides the benefit of flexible UL scheduling. However, such benefits also have associated costs. First, more available UL bands and/or carriers for dynamic UL Tx switching can result in more frequent switching instances and, depending on UE capability, those switching instances can require switching gaps during which the carriers cannot be used for transmission. Second, the increased number of UL bands and/or carriers for dynamic UL Tx switching can result in longer switching gap duration, depending upon the switching case and the corresponding initial and final state of UL Tx chain. Consequently, the above aspects may increase UE implementation complexity, including processing requirements, when accommodating more bands for UL Tx switching.

The present disclosure provides solutions that mitigate these costs associated with the increase in the number of bands and/or carrier for dynamic UL Tx. To mitigate these costs, the present disclosure describes solutions that limit/restrict the possibility of frequent switching instances between bands and/or carriers, establishes particular criteria used to limit/restrict frequency switching instances, and defines signaling enhancements to enable such restrictions.

These benefits can be achieved, in general, by configuring a UE with dynamic UL Tx switching capability for a given switching instance only once within a duration of X time units. This can be described additionally, or alternatively, as the minimum gap between the two switching instances for the given switching case must be at least a duration of X time units, wherein the duration of X time units can be determined based on one or more of (i) minimum required switching gap for the given switching case, (ii) UE processing capability type, (iii) associated priority such as traffic priority is URLLC or eMBB, (iv) associated priority with the configured bands/carriers, (v) band type such as SUL, NUL, or (vi) frequency range such as FR1, FR2 (2-1, 2-2).

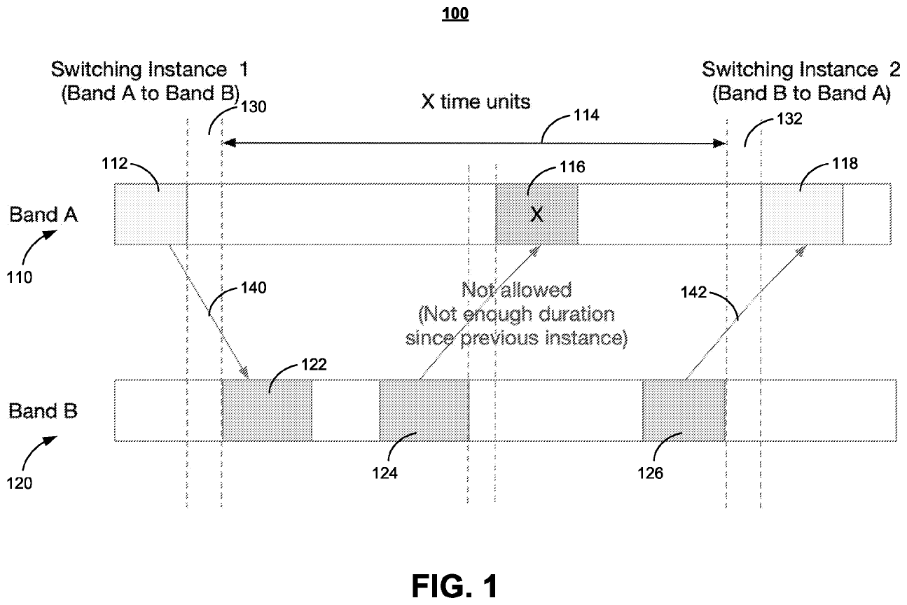

The terms “duration of X time units”/“minimum required switching gap”/“minimum gap”/“a minimum duration of time,” “switching instance,” “switching case,” and “state of a UL Tx chain” can be readily understood with reference to FIG. 1.

FIG. 1 is a conceptual diagram 100 of a switching event that highlights concepts related to dynamic uplink TX switching.

The diagram 100 depicts a first band A 110 and a second band B 120, where a band is a spectrum for uplink transmission in frequency range. In scenario of diagram 100, the UE is initially performing UL Tx on band A 110 at 112. Thus, the initial “state of the UL Tx chain” is that UL Tx on band A 110 or merely “band A 110.” Then, the UE switches 140 UL Tx from the initial state of the UL Tx chain (e.g., band A 110) to band B 120 at 122, which may be referred to as a subsequent “state of the UL Tx chain.”

For purposes of this specification, the switching event that occurs at 140 is referred to as a “switching instance” 130. Such a “switching instance” is an actual occurrence of a “switching case,” which may be described as example of a particular switching event from an initial state of the UL Tx chain to a subsequent state of the UL Tx chain. Thus, each “switching instance” will have an initial “state of the UL Tx” (e.g., band A) and a subsequent “state of the UL Tx” (e.g., band B), where each “state of the UL Tx” can include one or more bands or carriers. In some instances, a switching instance 130 can require a switching gap 130a where bands (or carriers) cannot be used for a portion of time.

In the diagram 100, a duration of X time units”/“minimum required switching gap”/“minimum gap”/“a minimum duration of time,” or the like is depicted as a duration of X time units 114. This duration of X time units is the minimum duration of time that a UE has been configured to wait from completion of the first switching instance to when the UE can perform another UL Tx switching event, shown in diagram 100 as switching instance 2 132, which causes a switching gap 132a.

In accordance with the present disclosure, each UE may be configured with dynamic UL Tx switching criteria such as a dynamic UL Tx switching mapping table. In some implementations, the UL Tx switching mapping table stores an association between a “switching case” and a corresponding respective “minimum duration of time” (or “duration of X time units”/“minimum required switching gap”/“minimum gap”/“a minimum duration of time) specifying a minimum amount of time that is required to pass until a UE can perform another UL Tx switching event after the UE performs a prior UL Tx switching event corresponding to a the particular switching case in the dynamic UL Tx switching mapping table. At any given time, such a dynamic UL Tx switching table may store a plurality of switching cases, each with a corresponding minimum duration of time.

In example of FIG. 1, diagram 100 illustrates that a UE configured to perform dynamic UL Tx switching in accordance with the aspects of the present disclosure would be prohibited from UL Tx switching from band B 120 to band A 110 at 116 because the minimum duration of time X from the prior switching instance 1 130 has not yet elapsed. As a result, a UE configured to perform dynamic UL Tx switching in accordance with the present disclosure will be prohibited from UL Tx switching to band A 110 at 116.

Continuing with the example of FIG. 1 and diagram 100, once the minimum duration of time X has elapsed, the UE can perform another UL Tx switching event. In the example of FIG. 1 and diagram 100, the UE performs a UL Tx switching event at 142 from a current initial UL Tx chain state band B 120 to a subsequent UL Tx chain state band A at 118. A UE configured in accordance with present disclosure then remains performing UL Tx on band A 110 until a minimum duration of time corresponding to the switching case band B to band A specified by the dynamic UL Tx switching criteria has elapsed.

### Methods for Scheduling Dynamic UL Tx Switching

In some implementations, a process for dynamic UL Tx switching can begin with a UE reporting, for example, using a UE capability report, one or more of (i) a set of switching cases that the UE is capable of supporting for dynamic UL Tx switching, (ii) a switching gap corresponding to the switching cases, and (iii) UE processing capability type (for example type 1, type2) to an access node. The access node can then determine minimum durations of time for each switching case based on the aforementioned information. Such information may be reported by the UE using, for example, RRC signaling.

In addition to such information, the access node can also consider information such as (a) associated traffic priority, (b) associated priority with one or more switching cases, (c) type of switching case, or (d) frequency range in determining the minimum duration of time for each switching case. This information may be received from the UE as part of the UE capability report or other transmission from the UE. Alternatively, this information may be obtained, or otherwise known, by the access node independent of a transmission of this information from the UE.

Up on receiving the report from the UE, the access node can configure the UE using, for example, RRC signaling. In some implementations, the UE receives configuration from the network with a mapping between: (i) switching cases and minimum allowed duration between the two instances of same switching case and (ii) switching cases and the minimum allows duration between the two instances of two different switching cases.

The UE, upon receiving the above configuration, is not expected to be scheduled with a UL Tx switching event with two switching cases, in succession, that have minimum duration between the two switching cases of less than the one indicated by mapping table.

An example of mapping table that associates each switching case of a plurality of switching cases with corresponding minimum duration that is required to elapse after the occurrence of each switching case is shown below in Table 1:

TABLE 1

| | | Minimum Duration Between |
|---|---|---|
| Index | Switching Case | Switching Instances (ms) |
| 0 | Band A to Band B | .25 |
| 1 | Band A, Band B to Band C | .5 |
| 2 | Band A, Band B to Band C, | .75 |
| | Bank D | |

With reference to Table 1, after a switching event having a switching instances of Band A to Band B occurs, a UE can determine, based on Table 1, for example, that the UE is required to wait 0.25 ms before performing another UL Tx switching event.

### Examples of Different UL Tx Switching Instances

The present disclosure supports multiple different types of UL Tx switching events and/or UL Tx switching instances. For example, there an initial UL Tx switching state may have the same number of bands or carriers than a subsequent UL Tx switching state. Alternatively, an initial UL Tx switching state may have more bands or carriers than a subsequent UL Tx switching sate. In yet other alternatives, an initial UL Tx switching sate may have less bands or carriers than a subsequent initial UL Tx switching state.

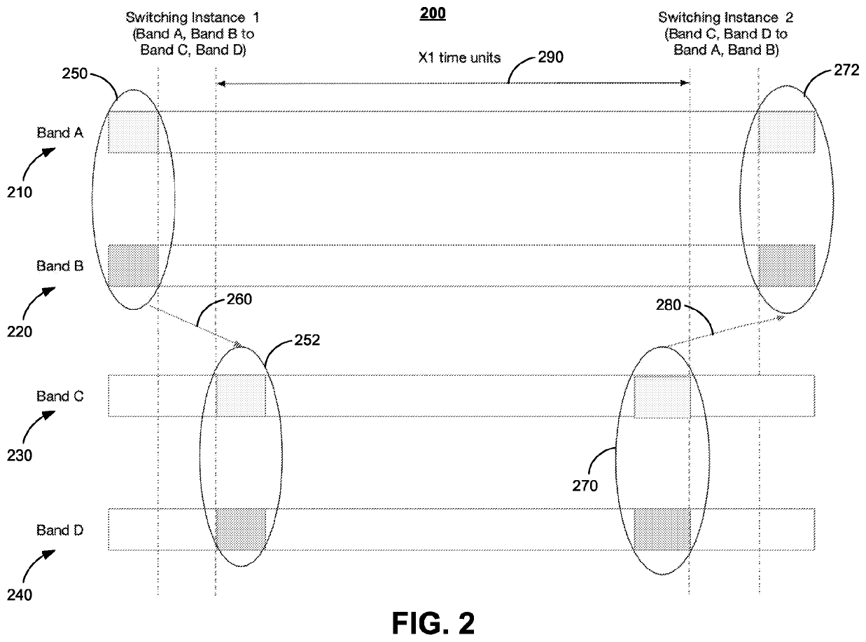

FIG. 2 is a conceptual diagram 200 of an example of a two switching instances that are the same. In the example of FIG. 2, there are four different bands—i.e., band A 210, band B 220, band C 230, and band D 240, as depicted by diagram 200. The initial UL Tx state prior is “band A and band B” 250. Then, there is a switching event 260 that results in a first switching instance of “band A and band B” to “band C and band D,” which causes a switching gap 262. A UE configured with dynamic UL Tx switching criteria in accordance with the present disclosure is then prohibited from performing another UL Tx switch until the minimum duration X1 290 elapses. Then, after the minimum duration X1 290 elapses, another switching event 280 occurs resulting in a UL Tx switch from “band C and band D” 270 to “band B and band A” 272, which cause a switching gap 282. Thus, in this example, the second switching instance is the type of switching instance as the first switching instance—i.e., both switching instances are from two bands to two bands.

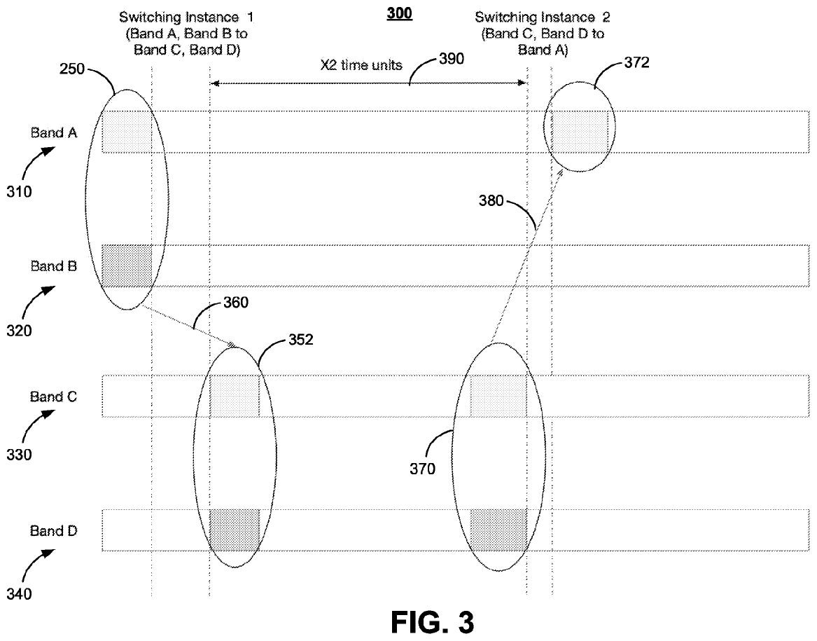

FIG. 3 is a conceptual diagram 300 of an example of two switching instances that are different. The example of FIG. 3 likewise includes four different bands—i.e., band A 310, band B 320, band C 330, and band D 240, as depicted by diagram 300. Then, there is a switching event 360 that results in a first switching instance of “band A and band B” to “band C and band D,” which causes switching gap 362. A UE configured with dynamic UL Tx switching criteria in accordance with the present disclosure is then prohibited from performing another UL Tx switch until the minimum duration X2 390 elapses. Then, after the minimum duration X2 390 elapses, another switching event 380 occurs resulting in a UL Tx switch from “band C and band D” 270 to “band A” 372, which causes a switching gap 382. Thus, in this example, the second switching instances is a different type of switching instance—i.e., the first switching instances is from two bands to two bands and the second switching instances is from two bands to one band.

In this illustration, it could be seen that the minimum required duration between the two instances of switching in diagram 200 of FIG. 2 is larger than the minimum required duration between the two instances of switching in diagram 300 of FIG. 3. Specifically, in this example, the minimum duration X1 290 is greater than the minimum duration X2 390. Likewise, some switching instances like switching instance 280 can be associated with a longer switching gap 282 than other switching instances 380, which may have a smaller switching gap 382. Accordingly, providing certain UE configurations with longer minimum durations allows the capability to limit certain switching instances more by associating certain switching instances with a higher minimum required duration between switching instances. Likewise, such configurations also allows the capability configure UE to perform other switching instances, as necessary, by assigning certain switching instances a lower minimum required duration than other switching instances.

### Other Implementations

In some implementations, multiple mappings in, for example, a dynamic UL Tx switching mapping table, can be configured to the UE in terms of minimum duration between 2 switching instances of switching cases. For example, in some implementations, one mapping can be provided for UE capability type 1 and another mapping can be provided for UE capability type 2.

In some implementations, the minimum duration between two switching instances of switching cases is mapped in, for example, a dynamic UL Tx switching mapping table, to number of configured bands and/or number of configured carriers/bands for dynamic UL Tx switching. For example, in one implementation, a mapping table is configured to UE, where mapping of 2, 3 and 4 configured bands is provided corresponding to the minimum duration between 2 switching instances of switching cases.

In some implementations, the minimum duration between two instances of switching cases is mapped in, for example, a dynamic UL Tx switching mapping table, to each of the supported switching mode by UE. For example, in one implementation, a mapping table is configured to UE, where mapping of switched UL mode and mapping of dual UL is provided corresponding to the minimum duration between 2 instances of switching cases. In such implementations, a switch UL mode is a mode where simultaneous UL transmission on 2 Tx chains is not allowed and dualUL mode is a mode where simultaneous UL transmission on 2 Tx chains is allowed.

In some implementations, the minimum required duration between two instances of switching cases (corresponding to a given switching case) is configured/indicated in terms of number of slots/symbol, where the number of slots/symbols are based on the numerology associated with the carriers.

For the case of dual UL, when 2 carriers are used for simultaneous UL transmission, and if the 2 carriers have different numerologies associated with them, then the number of slots/symbols to determine the duration between two instances of switching cases is determined based on the higher of 2 associated numerologies i.e. lower symbol duration.

In some implementations, the minimum required duration between two instances of switching cases (corresponding to give switching case) is associated with the state change of the UL Tx chains. In one example of such an implementation, a first value of minimum required duration between the two switching instances is configured/indicated for scenario where the state of both the UL Tx chains change in the two switching instances. In example, a second value of minimum required duration between the two switching instances is configured/indicated for scenario where the state of both the UL Tx chains change in the one switching instance and state of only one Tx chain changes in another switching instance. In the example, a third value of minimum required duration between the two switching instances is configured/indicated for scenario where the state of only one UL Tx chain change in each of the two switching instances. Then, in such implementations, a different minimum duration can be used, by the UE, based on the type of switching case that occurs.

While each of these and other implementations described here are described individually, the present disclosure is not limited to only one of these implementations. Instead, according to described methods for mapping different switching scenarios and corresponding minimum required duration between two switching instances, a combination of two or more of these described methods can also be applied.

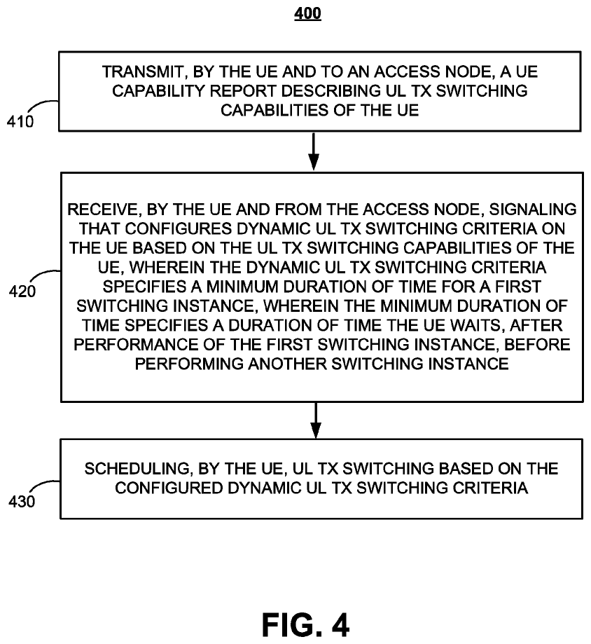

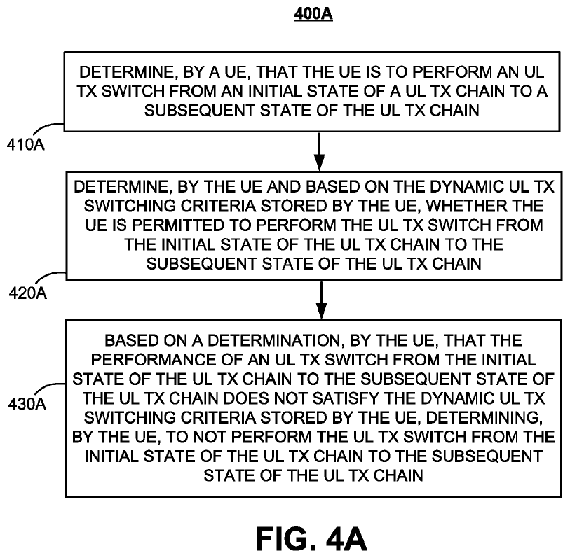

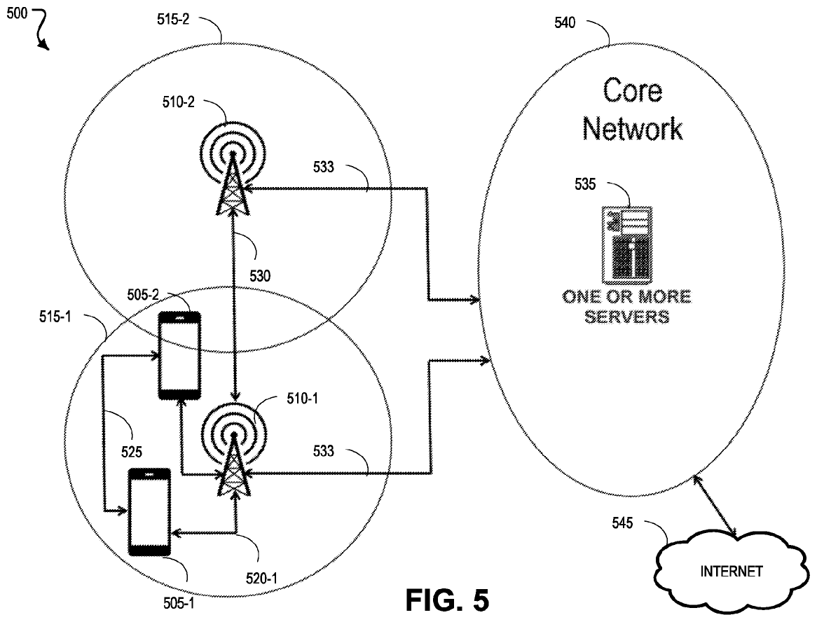

FIG. 4. is a flowchart of an example of a process 400 for dynamic uplink (UL) transmission (Tx) switching, in accordance with one aspect of the present disclosure. The process 400 will be described as being performed by a UE such as UE 505 of FIG. 5.

A UE can begin execution of the process 400 by transmitting, to an access node, UE capability report describing UL Tx switching capabilities of the UE (410).

The UE can continue execution of the process 400 by receiving, from the access node, signaling that configures dynamic UL Tx switching criteria on the UE based on the UL Tx switching capabilities of the UE, wherein the dynamic UL Tx switching criteria specifies a minimum duration of time for a first switching instance, wherein the minimum duration of time specifies a duration of time the UE waits, after performance of the first switching instance, before performing another switching instance. (420).

The UE can continue execution of the process 400 by scheduling UL Tx switching based on the configured dynamic UL Tx switching criteria (430).

In some implementations, the first switching instance corresponds to an UL Tx switch from an initial state of a UL Tx chain to a subsequent state of the UL Tx chain and the other switching instance corresponds to an UL Tx switch from the subsequent state of the UL Tx chain to any other state of the UL Tx chain.

In some implementations, the minimum duration of time specified by the dynamic UL Tx switching criteria is specified in terms of a number of slots or symbols. In such implementations, the number of slots or symbols is based on the numerology associated with each band or carrier of the switching case. In such implementations, each switching case can include a carrier or a band. In other implementations, the minimum duration of time is associated with the stage change of UL Tx chains.

In some implementations, the initial state of a UL Tx chain can include a single band and the subsequent state of the UL Tx chain can include a single band.

In some implementations, the initial state of a UL Tx chain can include multiple bands and the subsequent state of the UL Tx chain can include a single band.

In some implementations, the initial state of a UL Tx chain can include a single band and the subsequent state of the UL Tx chain can include multiple bands.

In some implementations, the UE capability report describing UL Tx switching capabilities can include (i) a set of switching cases that the UE is capable of supporting for dynamic UL Tx switching, (ii) a minimum required switching gap for a given switching case, (iii) UE processing capability type, (iv) associated traffic priority, (v) associated priority with one or more switching cases, (vi) type of switching case, (vii) frequency range, or any combination thereof, in determining a minimum duration of time for a subsequent UL Tx switching event.

In some implementations, the associated traffic priority can include, for example, URLLC or eMBB.

In some implementation, the associated priority with one or more switching cases includes an associated priority with one or more bands or one or more carriers.

In some implementations, the type of switching case includes a band type. In some implementations, the band type can include, for example, SUL or NUL.

In some implementations, the dynamic UL Tx switching criteria includes a dynamic UL Tx switching mapping table. In such implementations, the UE can continue execution of the process 400 by determining a particular switching instance, wherein a particular switching instance includes an UL Tx switch from an initial state of a UL Tx chain to a subsequent state of the UL Tx chain. The UE's execution of the process 400 can continue with the UE determining a duration of time that corresponds to the particular switching instance based from the dynamic uplink mapping table. In such implementations, the UE's execution of stage 430 of process 400 can include the UE scheduling UL Tx switching without an occurrence of an UL Tx switch from the subsequent state of the UL Tx chain to any other state of the UL Tx chain for at least the determined duration of time.

In some implementations, the dynamic UL Tx switching mapping table can include a plurality of entries, wherein each entry in the dynamic UL Tx switching mapping table corresponds to particular switching case. In some implementations, the dynamic UL Tx switching mapping table can include a plurality of entries, wherein each entry in the dynamic UL Tx switching mapping table associates (i) a particular switching case with (ii) a minimum duration that must elapse after a switching instances occurs that corresponds to the particular switching case before the UE can perform another UL Tx switch. In some implementations, each entry in the dynamic UL Tx switching mapping table includes an index.

In some implementations, the dynamic UL Tx switching criteria on the UE can be determined based on the UL Tx switching capabilities of the UE.

In some implementations, the dynamic UL Tx switching criteria can include multiple different sets of dynamic UL Tx switching criteria. In such implementations, each set of dynamic UL Tx switching criteria can be associated with a UE capability type. A UE capability can include, for example, a device type. For example, a UE can be a Type 1 device, a Type 2 device, or the like. In such implementations, the UE's execution of stage 430 can include the UE scheduling UL Tx switching based on the configured dynamic UL Tx switching criteria by determining an actual UE capability type for the UE, and then scheduling UL Tx switching based on the dynamic UL Tx switching criteria that is associated with the actual UE capability type determined by the UE.

In some implementations, the dynamic UL Tx switching criteria includes multiple different sets of dynamic UL Tx switching criteria. In such implementations, each set of dynamic UL Tx switching criteria is associated with a UE switching mode. In such implementations, the UE's execution of stage 430 can include the UE determining, by the UE, an actual UE switching mode for the UE, and then scheduling, by the UE, UL Tx switching based on the dynamic UL Tx switching criteria that is associated with the actual UE switching mode determined by the UE. In some implementations, the UE switching mode can include (i) a switched UL or (ii) a dual UL mode. Switch UL is a switching mode where simultaneous UL Tx on 2 Tx chains is not allowed. Dual UL mode is a switching mode where simultaneous UL transmission on 2 Tx chains is allowed.

In some implementations, the UE transmits signaling describing UL Tx switching capabilities of the UE to the access node using radio resource control (RRC) signaling.

In some implementations, the UE receives signaling that configures dynamic UL Tx switching criteria on the UE based on the UL Tx switching capabilities of the UE from the access node using radio resource control (RRC) signaling.

FIG. 4A is a flowchart of an example of another process 400A for dynamic UL Tx switching, in accordance with one aspect of the present disclosure. The process 400A will be described as being performed by a UE such as UE 505 of FIG. 5. A UE can begin execution of the process 400A by determining that the UE is to perform an UL Tx switch from an initial state of a UL Tx chain to a subsequent state of the UL Tx chain (410A).

The UE can continue execution of the process 400A by determining, based on dynamic UL Tx switching criteria stored by the UE, whether the UE is permitted to perform the UL Tx switch from the initial state of the UL Tx chain to the subsequent state of the UL Tx chain (420A).

Then, based on a determination by the UE at stage 420A that the performance of an UL Tx switch from the initial state of the UL Tx chain to the subsequent state of the UL Tx chain does not satisfy the dynamic UL Tx switching criteria stored by the UE, the UE can continue execution of the process 400A by determining to not perform the UL Tx switch from the initial state of the UL Tx chain to the subsequent state of the UL Tx chain (430).

Alternatively, in some implementations, based on a determination, by the UE at stage 420A, that the performance of an UL Tx switch from the initial state of the UL Tx chain to the subsequent state of the UL Tx chain satisfies the dynamic UL Tx switching criteria stored by the UE, performing, by the UE, the UL Tx switch from the initial state of the UL Tx chain to the subsequent state of the UL Tx chain.

In some implementations, the initial state of the UL Tx chain can include a single band or a single carrier and the subsequent state includes a single bad or a single carrier.

In some implementations, the initial state of the UL Tx chain can include multiple bands and the second set of one or more bands includes a single band.

In some implementations, the initial state of the UL Tx chain can include a single band and the second set of one or more bands includes multiple bands.

In some implementations, the initial state of the UL Tx chain can include multiple bands and the second set of one or more bands includes multiple bands.

In some implementations, the dynamic UL Tx switching criteria can include a predetermined minimum duration of time between the initial state of the UL Tx chain and the second set of one or more bands.

In some implementations, the dynamic UL Tx switching criteria can include a dynamic uplink UL Tx switching mapping table.

In some implementations, the dynamic UL Tx switching mapping table can include a plurality of entries, wherein each entry in the dynamic UL Tx switching mapping table corresponds to a particular switching case.

In some implementations, the dynamic UL Tx switching mapping table can include a plurality of entries, wherein each entry in the dynamic UL Tx switching mapping table associates (i) a particular switching case with (ii) a minimum duration that must elapse after a switching instance occurs that corresponds to the particular switching case before the UE can perform another UL Tx switch.

In some implementations, each entry in the dynamic UL Tx switching mapping table can include an index.

### RRC Configurations

In some implementations, RRC configuration can be enhanced to configure the UE functionality described herein.

The IE BandCombinationList can be updated with a new parameter to indicate the general support for UL Tx switching mechanism with minimum duration requirement between two instances of switching.

IE CellGroupConfig information element can be updated with one or more parameters to provide UL Tx switching with minimum duration requirement configuration including one or more of (i) configure one minimum duration value for all cases, (ii) configure one minimum duration value for each of the 2, 3 and 4 bands UL Tx switching mechanism, (iii) configure one minimum duration value for each of switching mode, (iv) one for switchedUL, and (v) one for dualUL.

In some implementations, the IE CellGroupConfig information element can configure a set of minimum duration values and from which, network can configure one or multiple values to the UE. This may be implementation dependent or could be based on some UE reported capability.

FIG. 5 is a diagram of an example of a wireless communication system 500, according to some implementations. It is noted that the system of FIG. 5 is merely one example of a possible system, and that features of this disclosure may be implemented in other wireless communication systems.

The following description is provided for an example communication system 500 that operates in conjunction with fifth generation (5G) networks as provided by 3rd Generation Partnership Project (3GPP) technical specifications (TS). However, the example implementations are not limited in this regard and the described implementations may apply to other networks that may benefit from the principles described herein, such as 3GPP Long Term Evolution (LTE) networks, Wi-Fi or Worldwide Interoperability for Microwave Access (WiMax) networks, and the like. Furthermore, other types of communication standards are possible, including future 3GPP systems (e.g., Sixth Generation (6G)) systems, IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

As shown, the communication system 500 includes a number of user devices. As used herein, the term “user devices” may refer generally to devices that are associated with mobile actors or traffic participants in the communication system 500, e.g., mobile (able-to-move) communication devices such as vehicles and pedestrian user equipment (PUE) devices. More specifically, the V2X communication system 500 includes two UEs 505 (UE 505-1 and UE 505-2 are collectively referred to as “UE 505” or “UEs 505”), two base stations 510 (base station 510-1 and base station 510-2 are collectively referred to as “base station 510” or “base stations 510”), two cells 515 (cell 515-1 and cell 515-2 are collectively referred to as “cell 515” or “cells 515”), and one or more servers 535 in a core network (CN) 540 that is connected to the Internet 545.

As shown, certain user devices may be able to conduct communications with one another directly, i.e., without an intermediary infrastructure device such as base station 510-1. As shown, UE 505-1 may conduct communications (e.g., V2X-related communications) directly with UE 505-2. Similarly, the UE 505-2 may conduct communications directly with UE 505-2. Such peer-to-peer communications may utilize a “sidelink” interface such as a PC5 interface. In certain implementations, the PC5 interface supports direct cellular communication between user devices (e.g., between UEs 505), while the Uu interface supports cellular communications with infrastructure devices such as base stations. For example, the UEs 505 may use the PC5 interface for a radio resource control (RRC) signaling exchange between the UEs. The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

The PC5 interface may alternatively be referred to as a SL interface and may include one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH). In some examples, the SL interface can operate on an unlicensed spectrum (e.g., in the unlicensed 5 Gigahertz (GHz) and 6 GHz bands) or a (licensed) shared spectrum.

In some implementations, UEs 505 may be physical hardware devices capable of running one or more applications, capable of accessing network services via one or more radio links 520 with a corresponding base station 510, and capable of communicating with one another via sidelink 525. Link 520 may allow the UEs 505 to transmit and receive data from the base station 510 that provides the link 520. The sidelink 525 may allow the UEs 505 to transmit and receive data from one another. The sidelink 525 between the UEs 505 may include one or more channels for transmitting information from UE 505-1 to UE 505-2 and vice versa and/or between UEs 505 and UE-type RSUs (not shown in FIG. 5) and vice versa.

In some implementations, the channels may include the Physical Sidelink Broadcast Channel (PSBCH), Physical Sidelink Control Channel (PSCCH), Physical Sidelink Discovery Channel (PSDCH), Physical Sidelink Shared Channel (PSSCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. The SCI in NR V2X is transmitted in two stages. The 1st-stage SCI in NR V2X is carried on the PSCCH while the 2nd-stage SCI is carried on the corresponding PSSCH. For example, 2-stage SCI can be used by applying the 1^{st} SCI for the purpose of sensing and broadcast communication, and the 2^{nd} SCI carrying the remaining information for data scheduling of unicast/groupcast data transmission.

In some implementations, the sidelink 525 is established through an initial beam pairing procedure. In this procedure, the UEs 505 identify (e.g., using a beam selection procedure) one or more potential beam pairs that could be used for the sidelink 525. A beam pair includes a transmitter beam from a transmitter UE (e.g., UE 505-1) to a receiver UE (e.g., UE 505-2) and a receiver beam from the receiver UE to the transmitter UE. In some examples, the UEs 505 rank the one or more potential beam pairs. Then, the UEs 505 select one of the one or more potential beam pairs for the sidelink 525, perhaps based on the ranking.

As stated, the air interface between two or more UEs 505 or between a UE 505 and a UE-type RSU (not shown in FIG. 5) may be referred to as a PC5 interface. To transmit/receive data to/from one or more eNBs 510 or UEs 505, the UEs 505 may include a transmitter/receiver (or alternatively, a transceiver), memory, one or more processors, and/or other like components that enable the UEs 505 to operate in accordance with one or more wireless communications protocols and/or one or more cellular communications protocols. The UEs 505 may have multiple antenna elements that enable the UEs 505 to maintain multiple links 520 and/or sidelinks 525 to transmit/receive data to/from multiple base stations 510 and/or multiple UEs 505. For example, as shown in FIG. 5, UE 505 may connect with base station 510-1 via link 520 and simultaneously connect with UE 505-2 via sidelink 525.

In some implementations, the UEs 505 are configured to use a resource pool for sidelink communications. A sidelink resource pool may be divided into multiple time slots, frequency channels, and frequency sub-channels. In some examples, the UEs 505 are synchronized and perform sidelink transmissions aligned with slot boundaries. A UE may be expected to select several slots and sub-channels for transmission of the transport block. In some aspects, a UE may use different sub-channels for transmission of the transport block across multiple slots within its own resource selection window, which may be determined using packet delay budget information.

In some implementations, the communication system 500 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

In some implementations, the UEs 505 are configured to perform sidelink beam failure recovery procedures. The V2X communication system 500 can enable or disable support of the sidelink beam failure recovery procedures in the UEs 505. More specifically, the V2X communication system 500 can enable or disable support per resource pool or per PC5-RRC configuration (which may depend on UE capability). In the sidelink beam failure recovery procedures, one of the UEs 505 is designated as a transmitter UE (e.g., UE 505-1) and the other UE is designated as a receiver UE (e.g., UE 505-2). For the purposes of this disclosure, a UE that detects a beam failure is designated as the receiver UE and the other UE is designated as the transmitter UE. More generally, a transmitter UE is the UE sending sidelink data, and the receiver UE is the UE receiving the sidelink data. Furthermore, although this disclosure describes a single transmitter UE and single receiver UE, the disclosure is not limited to this arrangement and can include more than one transmitter UE and/or receiver UE.

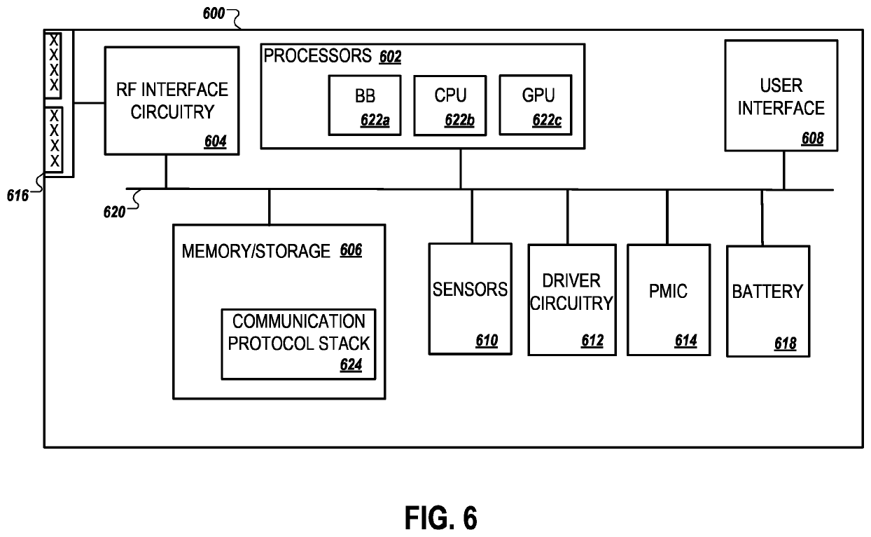

FIG. 6 is a block diagram of an example of user equipment (UE). The UE 600 may be similar to and substantially interchangeable with UEs 505 of FIG. 5.

The UE 600 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 600 may include processors 602, RF interface circuitry 604, memory/storage 606, user interface 608, sensors 610, driver circuitry 612, power management integrated circuit (PMIC) 614, antenna structure 616, and battery 618. The components of the UE 600 may be implemented as integrated circuits (ICs), portions thereof, discrete electronic devices, or other modules, logic, hardware, software, firmware, or a combination thereof. The block diagram of FIG. 6 is intended to show a high-level view of some of the components of the UE 600. However, some of the components shown may be omitted, additional components may be present, and different arrangement of the components shown may occur in other implementations.

The components of the UE 600 may be coupled with various other components over one or more interconnects 620, which may represent any type of interface, input/output, bus (local, system, or expansion), transmission line, trace, optical connection, etc. that allows various circuit components (on common or different chips or chipsets) to interact with one another.

The processors 602 may include processor circuitry such as, for example, baseband processor circuitry (BB) 622A, central processor unit circuitry (CPU) 622B, and graphics processor unit circuitry (GPU) 622C. The processors 602 may include any type of circuitry or processor circuitry that executes or otherwise operates computer-executable instructions, such as program code, software modules, or functional processes from memory/storage 606 to cause the UE 600 to perform operations as described herein.

In some implementations, the baseband processor circuitry 622A may access a communication protocol stack 624 in the memory/storage 606 to communicate over a 3GPP compatible network. In general, the baseband processor circuitry 622A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 604. The baseband processor circuitry 622A may generate or process baseband signals or waveforms that carry information in 3GPP-compatible networks. In some implementations, the waveforms for NR may be based cyclic prefix OFDM “CP-OFDM” in the uplink or downlink, and discrete Fourier transform spread OFDM “DFT-S-OFDM” in the uplink.

The memory/storage 606 may include one or more non-transitory, computer-readable media that includes instructions (for example, communication protocol stack 624) that may be executed by one or more of the processors 602 to cause the UE 600 to perform various operations described herein. The memory/storage 606 include any type of volatile or non-volatile memory that may be distributed throughout the UE 600. In some implementations, some of the memory/storage 606 may be located on the processors 602 themselves (for example, L1 and L2 cache), while other memory/storage 606 is external to the processors 602 but accessible thereto via a memory interface. The memory/storage 606 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 604 may include transceiver circuitry and radio frequency front module (RFEM) that allows the UE 600 to communicate with other devices over a radio access network. The RF interface circuitry 604 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 616 and proceed to filter and amplify (with a low-noise amplifier) the signal. The signal may be provided to a receiver of the transceiver that downconverts the RF signal into a baseband signal that is provided to the baseband processor of the processors 602.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 616.

In various implementations, the RF interface circuitry 604 may be configured to transmit/receive signals in a manner compatible with NR access technologies.

The antenna 616 may include antenna elements to convert electrical signals into radio waves to travel through the air and to convert received radio waves into electrical signals. The antenna elements may be arranged into one or more antenna panels. The antenna 616 may have antenna panels that are omnidirectional, directional, or a combination thereof to enable beamforming and multiple input, multiple output communications. The antenna 616 may include microstrip antennas, printed antennas fabricated on the surface of one or more printed circuit boards, patch antennas, phased array antennas, etc. The antenna 616 may have one or more panels designed for specific frequency bands including bands in FRI or FR2.

The user interface 608 includes various input/output (I/O) devices designed to enable user interaction with the UE 600. The user interface 608 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 600.

The sensors 610 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 612 may include software and hardware elements that operate to control particular devices that are embedded in the UE 600, attached to the UE 600, or otherwise communicatively coupled with the UE 600. The driver circuitry 612 may include individual drivers allowing other components to interact with or control various input/output (I/O) devices that may be present within, or connected to, the UE 600. For example, driver circuitry 612 may include a display driver to control and allow access to a display device, a touchscreen driver to control and allow access to a touchscreen interface, sensor drivers to obtain sensor readings of sensor circuitry 628 and control and allow access to sensor circuitry 628, drivers to obtain actuator positions of electro-mechanic components or control and allow access to the electro-mechanic components, a camera driver to control and allow access to an embedded image capture device, audio drivers to control and allow access to one or more audio devices.

The PMIC 614 may manage power provided to various components of the UE 600. In particular, with respect to the processors 602, the PMIC 614 may control power-source selection, voltage scaling, battery charging, or DC-to-DC conversion.

In some implementations, the PMIC 614 may control, or otherwise be part of, various power saving mechanisms of the UE 600 including DRX as discussed herein. A battery 618 may power the UE 600, although in some examples the UE 600 may be mounted deployed in a fixed location, and may have a power supply coupled to an electrical grid. The battery 618 may be a lithium ion battery, a metal-air battery, such as a zinc-air battery, an aluminum-air battery, a lithium-air battery, and the like. In some implementations, such as in vehicle-based applications, the battery 618 may be a typical lead-acid automotive battery.

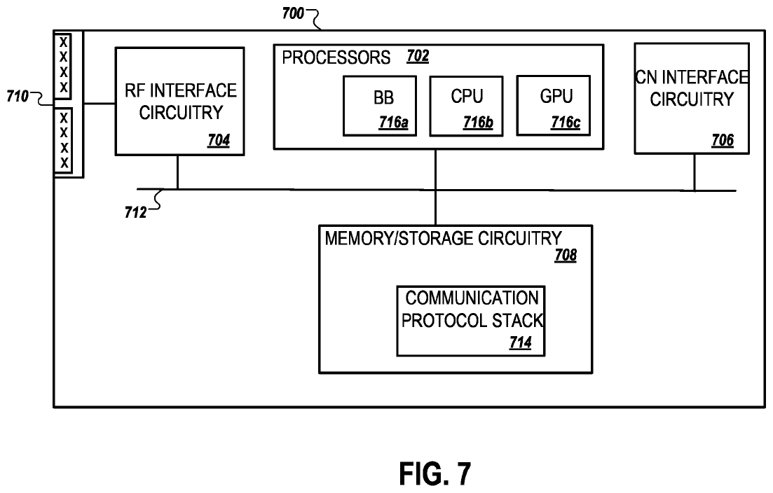

FIG. 7 is a block diagram of an example of an access node. FIG. 7 illustrates an access node 700 (e.g., a base station or gNB), in accordance with some implementations. The access node 700 may be similar to and substantially interchangeable with base stations 510. The access node 700 may include processors 702, RF interface circuitry 704, core network (CN) interface circuitry 706, memory/storage circuitry 708, and antenna structure 710.

The components of the access node 700 may be coupled with various other components over one or more interconnects 712. The processors 702, RF interface circuitry 704, memory/storage circuitry 708 (including communication protocol stack 714), antenna structure 710, and interconnects 712 may be similar to like-named elements shown and described with respect to FIG. 6. For example, the processors 702 may include processor circuitry such as, for example, baseband processor circuitry (BB) 716A, central processor unit circuitry (CPU) 716B, and graphics processor unit circuitry (GPU) 716C.

The CN interface circuitry 706 may provide connectivity to a core network, for example, a 5th Generation Core network (5GC) using a 5GC-compatible network interface protocol such as carrier Ethernet protocols, or some other suitable protocol. Network connectivity may be provided to/from the access node 700 via a fiber optic or wireless backhaul. The CN interface circuitry 706 may include one or more dedicated processors or FPGAs to communicate using one or more of the aforementioned protocols. In some implementations, the CN interface circuitry 706 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 700 that operates in an NR or 5G system (for example, a gNB), and the term “E-UTRAN node” or the like may refer to an access node 700 that operates in an LTE or 4G system (e.g., an eNB). According to various implementations, the access node 700 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 700 may be implemented as one or more software entities running on server computers as part of a virtual network, which may be referred to as a CRAN and/or a virtual baseband unit pool (vBBUP). In these implementations, the CRAN or vBBUP may implement a RAN function split, such as a PDCP split wherein RRC and PDCP layers are operated by the CRAN/vBBUP and other L2 protocol entities are operated by the access node 700; a MAC/PHY split wherein RRC, PDCP, RLC, and MAC layers are operated by the CRAN/vBBUP and the PHY layer is operated by the access node 700; or a “lower PHY” split wherein RRC, PDCP, RLC, MAC layers and upper portions of the PHY layer are operated by the CRAN/vBBUP and lower portions of the PHY layer are operated by the access node 700.

In V2X scenarios, the access node 700 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-13. (canceled)

14. One or more processors configured to, when executing instructions stored in a memory, perform operations comprising:
obtaining an indication of an uplink transmission switching configuration for a plurality of frequency bands;
determining a switching gap for the plurality of frequency bands according to the uplink transmission switching configuration;
instructing radio frequency (RF) circuitry to perform a first uplink transmission via a first set of carrier frequencies in a first frequency band of the plurality of frequency bands; and
after the determined switching gap, instructing the RF circuitry to perform a second uplink transmission via a second set of carrier frequencies in a second frequency band of the plurality of frequency bands.

15. The one or more processors of claim 14, wherein the uplink transmission switching configuration indicates a duration of the switching gap for the first frequency band and the second frequency band.

16. The one or more processors of claim 14, the operations further comprising instructing the RF circuitry to transmit uplink transmission switching capability information associated with the plurality of frequency bands.

17. The one or more processors of claim 16, wherein the uplink transmission switching capability information indicates a dual uplink transmission mode for the first frequency band and the second frequency band.

18. The one or more processors of claim 16, wherein the uplink transmission switching capability information indicates a switched uplink transmission mode for the first frequency band and the second frequency band.

19. The one or more processors of claim 16, wherein the uplink transmission switching capability information indicates a minimum switching gap for the first frequency band and the second frequency band.

20. The one or more processors of claim 16, wherein the uplink transmission switching configuration for the plurality of frequency bands is based at least on the uplink transmission switching capability information.

21. The one or more processors of claim 14, the operations further comprising switching from a first plurality of frequency bands to a second plurality of frequency bands during the switching gap between the first uplink transmission and the second uplink transmission.

22. The one or more processors of claim 21, wherein the first plurality of frequency bands comprises the first frequency band and the second plurality of frequency bands comprises the second frequency band.

23. The one or more processors of claim 14, the operations further comprising determining, based at least on the uplink transmission switching configuration, a transmit chain switching mode supported for the first frequency band and the second frequency band.

24. The one or more processors of claim 14, wherein the transmit chain switching mode is based at least on (i) a number of transmit chains supported on the first set of carrier frequencies in the first frequency band and (ii) a number of transmit chains supported on the second set of carrier frequencies in the second frequency band.

25. The one or more processors of claim 14, the operations further comprising instructing the RF circuitry to perform, during the determined switching gap, a third uplink transmission via a third set of carrier frequencies in a third frequency band of the plurality of frequency bands.

26. The one or more processors of claim 14, wherein the plurality of frequency bands comprises three or more frequency bands.

27. One or more processors configured to, when executing instructions stored in a memory, perform operations comprising:
instructing radio frequency (RF) circuitry to transmit an indication of an uplink transmission switching configuration for a plurality of frequency bands;
determining a switching gap for the plurality of frequency bands according to the uplink transmission switching configuration;
obtaining a first uplink transmission via a first set of carrier frequencies in a first frequency band of the plurality of frequency bands; and
obtaining, after the determined switching gap, a second uplink transmission via a second set of carrier frequencies in a second frequency band of the plurality of frequency bands.

28. The one or more processors of claim 27, wherein the uplink transmission switching configuration indicates a duration of the switching gap for the first frequency band and the second frequency band.

29. The one or more processors of claim 27, the operations further comprising obtaining uplink transmission switching capability information associated with the plurality of frequency bands.

30. The one or more processors of claim 29, wherein the uplink transmission switching capability information indicates a dual uplink transmission mode for the first frequency band and the second frequency band.

31. The one or more processors of claim 29, wherein the uplink transmission switching capability information indicates a switched uplink transmission mode for the first frequency band and the second frequency band.

32. The one or more processors of claim 29, wherein the uplink transmission switching capability information indicates a minimum switching gap for the first frequency band and the second frequency band.

33. A method comprising:
receiving an indication of an uplink transmission switching configuration for a plurality of frequency bands;
determining a switching gap for the plurality of frequency bands according to the uplink transmission switching configuration;
transmitting a first uplink transmission via a first set of carrier frequencies in a first frequency band of the plurality of frequency bands; and
transmitting, after the determined switching gap, a second uplink transmission via a second set of carrier frequencies in a second frequency band of the plurality of frequency bands.
